(19) United States
(12) Patent Application Publication
(10) Pub. No.: US 2023/0038067 A1
(43) Pub. Date: Feb. 9, 2023

(54) OXYGEN CARRIER PARTICLES HAVING METAL OXIDE-PEROVSKITE CORE-SHELL STRUCTURE AND CHEMICAL-LOOPING WATER/CARBON DIOXIDE THERMOCHEMICAL DECOMPOSITION PROCESS USING SAME

(71) Applicant: KOREA ADVANCED INSTITUTE OF SCIENCE AND TECHNOLOGY, Daejeon (KR)

(72) Inventors: Jae W LEE, Daejeon (KR); Minbeom LEE, Daejeon (KR); Hyun Suk LIM, Daejeon (KR); Dohyung KANG, Daejeon (KR)

(21) Appl. No.: 17/758,573

(22) PCT Filed: Aug. 26, 2021
(86) PCT No.: PCT/KR2021/011427

§ 371 Date: Jul. 9, 2022

(30) Foreign Application Priority Data
Oct. 7, 2020 (KR) 10-2020-0129083
Jun. 23, 2021 (KR) 10-2021-0081544

(51) Int. Cl. C01B 3/06; B01J 23/83; B01J 23/10; B01J 23/755; B01J 23/745; B01J 23/75; B01J 23/00; B01J 35/00; B01J 37/02; B01J 37/08; B01J 37/04

(52) U.S. Cl. CPC C01B 3/063; B01J 23/83; B01J 23/10; B01J 23/755; B01J 23/745; B01J 23/75; B01J 23/002; B01J 35/0013; B01J 37/0221; B01J 37/0236; B01J 37/088; B01J 37/04

(57) ABSTRACT

The present invention relates to: oxygen carrier particles having a metal oxide-perovskite core-shell structure; and a chemical-looping thermochemical water/carbon dioxide splitting process using the same. By using the oxygen carrier particles having a metal oxide-perovskite core-shell structure in the chemical-looping thermochemical water/carbon dioxide splitting process, it is possible to produce hydrogen/carbon monoxide from water/carbon dioxide in high yield by efficiently overcoming the disadvantages of conventionally used oxygen carrier particles.

### TECHNICAL FIELD

The present invention relates to oxygen carrier particles having a metal oxide-perovskite core-shell structure, and a chemical-looping thermochemical water/carbon dioxide splitting process using the same, and more particularly, to a method of producing hydrogen/carbon monoxide from water/carbon dioxide in high yield by applying oxygen carrier particle having a metal oxide-perovskite core-shell structure to a thermochemical splitting process.

### BACKGROUND ART

Solar energy is a carbon-neutral energy source that can be continuously supplied and is infinite. It has attracted attention as an alternative resource to fossil fuels that generate excessive carbon dioxide. Various methods of producing fuel using solar energy have been proposed as follows.

First, studies have been conducted on the conversion of water and carbon dioxide into solar fuel using a photocatalytic reaction. This reaction has an advantage in that it can convert water and carbon dioxide into various hydrocarbons, but it is not efficient enough to replace fossil fuels, due to disadvantages such as low activity and stability of the photocatalyst.

Thus, as an alternative thereto, a solar-thermal splitting method has been proposed. Solar thermal spitting is typically based on a process in which a material such as a metal oxide is reduced by exposure to a high temperature, and the reduced metal oxide is re-oxidized by exposure to a water or carbon dioxide atmosphere, thus producing hydrogen or carbon monoxide. Since solar thermal spitting shows higher efficiency than the photocatalytic reaction in the production of hydrogen and carbon monoxide, it has greater potential in the production of various fuels and high value-added substances. For example, a study conducted by J. A. Herron, et al. (J. A. Herron, et al., Energy Environ. Sci., 8, 126-157 (2015)) reported that the energy conversion efficiency of the latest research related to the photocatalytic reaction was only 0.2%, while the energy conversion efficiency of the process of producing hydrogen from water by solar thermal splitting reached 18%.

However, conventional solar thermal splitting requires a high temperature of 1,200° C. or higher to reduce a metal oxide and ensure sufficient conversion of water/carbon dioxide. This not only shows very high energy consumption, but also shows difficulties in the application of the technology because it is non-trivial to find oxygen carrier particles having high stability at the abovementioned operating temperature.

In order to overcome these problems, a chemical-looping thermochemical splitting process has emerged. Chemical-looping thermochemical splitting is based on a process in which a reducing agent such as methane, carbon monoxide or hydrogen is used to generate oxygen vacancies on the surface of oxygen carrier particles, and the reduced material is exposed to water/carbon dioxide to produce hydrogen/carbon monoxide. The chemical-looping thermochemical splitting has advantages in that, since the use of the reducing agent can reduce the oxygen carrier particles at a much lower temperature (800° C. or lower) than solar thermal splitting, the energy consumption of the overall process can be dramatically lowered, and the range of oxygen carrier particle candidate groups that can satisfy the conditions of high stability and activity at the corresponding operating temperature is wide due to mild operating conditions.

Until now, studies have been conducted to find oxygen carrier particles having high stability and activity in the chemical-looping thermochemical water/carbon dioxide splitting process, and as a result, two types of oxygen carrier candidate groups have been proposed.

Thereamong, as the first candidate group, metal oxides such as Fe₂O₃, Co₃O₄ and CeO₂ have been studied. They have attracted attention for their high accessibility and particularly high oxygen-carrying capacity (about 30 wt %) in the case of transition metals, but they have a disadvantage in that sintering may occur even at a relatively low operating temperature, and thus the particles can be inactivated (Z. Huang, et al., ACS Sustainable Chem. Eng., 7, 11621-11632 (2019)). On the other hand, perovskite in the form of ABO₃ has higher thermal stability, and thus can solve the problem of metal oxide, but it has a disadvantage in that the oxygen-carrying capacity thereof is low (about 10 wt %).

Accordingly, the present inventors have made efforts to produce oxygen carrier particles that can simultaneously satisfy high stability and activity in a hydrothermal water/carbon dioxide spitting process, and as a result, have found that, when oxygen carrier particles having a metal oxide-perovskite core-shell structure in which a metal oxide is surrounded by a perovskite-structured material are used, the metal oxide may improve sintering resistance while having structural stability, and the perovskite may have high lattice oxygen concentration and electronic conductivity, and thus the high oxygen-carrying capacity of the metal oxide in the core can be easily utilized and the metal oxide may also have high activity, so that all the disadvantages of each of the metal oxide and perovskite may be solved, thereby increasing the efficiency with which hydrogen and carbon monoxide are produced by water/carbon dioxide splitting. Based on this finding, the present invention has been completed.

### SUMMARY OF THE INVENTION

An object of the present invention is to provide oxygen carrier particles for producing hydrogen/carbon monoxide from water/carbon dioxide by a chemical-looping thermochemical splitting reaction, and a method for synthesizing the same.

Another object of the present invention is to provide a method of producing hydrogen/carbon monoxide in high yield by applying oxygen carrier particles having a metal oxide-perovskite core-shell structure to a chemical-looping thermochemical water/carbon dioxide splitting reaction, in which the oxygen carrier particles have high activity and stability by overcoming the disadvantages of each of the metal oxide and perovskite.

To achieve the above objectives, the present invention provides core-shell structured oxygen carrier particles comprising: a core containing a metal oxide; and a shell containing a perovskite surrounding a part or the whole of the core.

The present invention also provides a method of preparing the oxygen carrier particles, the method comprising steps of: (a) mixing a metal oxide nanoparticle suspension and a chelate solution containing a perovskite precursor, and drying the mixture; and (b) calcining the dried mixture, followed by cooling and powdering.

The present invention also provides a method of producing hydrogen from water by subjecting water to a chemical-looping thermochemical splitting reaction using a reducing agent and the oxygen carrier particles.

The present invention also provides a method of producing carbon monoxide from carbon dioxide by subjecting carbon dioxide to a chemical-looping thermochemical splitting reaction using a reducing agent and the oxygen carrier particles.

The present invention also provides a method of producing hydrogen and carbon monoxide from water and carbon dioxide by subjecting water and carbon dioxide to a chemical-looping thermochemical splitting reaction using a reducing agent and the oxygen carrier particles.

### BRIEF DESCRIPTION OF DRAWINGS

FIG. 1 is a schematic view showing a process of producing hydrogen/carbon monoxide by a chemical-looping thermochemical water/carbon dioxide splitting process according to the present invention.

FIG. 2 shows the X-ray diffraction patterns obtained by performing X-ray diffraction analysis of oxygen carrier particles 1-1 to 1-5 according to Example 2-1 of the present invention.

FIG. 3 shows the amount of consumed hydrogen calculated by performing hydrogen temperature programmed reduction analysis of oxygen carrier particles 1-1 to 1-5 and a control according to Example 3-1 of the present invention.

FIG. 4 shows the amount of produced carbon monoxide calculated by performing carbon dioxide temperature programmed oxidation analysis of oxygen carrier particles 1-1 to 1-5 and a control according to Example 3-2 of the present invention.

FIG. 5 shows the amount of produced carbon monoxide as a function of cycle number, measured when carbon monoxide was produced from carbon dioxide by a chemical-looping thermochemical splitting reaction using oxygen carrier particles 1-1 to 1-5 and perovskite (La_{0.75}Sr_{0.25}FeO₃) according to Examples 4-1 to 4-5 of the present invention and a Comparative Example.

FIG. 6 shows the amount of produced carbon monoxide as a function of cycle number, measured when carbon monoxide was produced from carbon dioxide by a chemical-looping thermochemical splitting reaction using oxygen carrier particles 1-6 according to Examples 4-6 of the present invention.

FIG. 7 shows the amount of produced carbon monoxide as a function of cycle number, measured during testing of the long-term stability of oxygen carrier particles 1-6 in an experiment of producing carbon monoxide from carbon dioxide by a chemical-looping thermochemical splitting reaction using oxygen carrier particles 1-6 according to Example 5 of the present invention.

FIG. 8 shows the amount of produced hydrogen as a function of cycle number, measured when hydrogen was produced from water (steam) by a chemical-looping thermochemical splitting reaction using oxygen carrier particles 1-3 and 1-6 according to Examples 6-1 and 6-2 of the present invention.

### DETAILED DESCRIPTION AND PREFERRED EMBODIMENTS OF THE INVENTION

Unless otherwise defined, all technical and scientific terms used in the present specification have the same meanings as commonly understood by those skilled in the art to which the present disclosure pertains. In general, the nomenclature used in the present specification is well known and commonly used in the art.

In the present invention, it has been found that, when core-shell structured oxygen carrier particles comprising a core containing a metal oxide and a shell containing perovskite surrounding a part or the whole of the core are applied to a chemical-looping thermochemical water/carbon dioxide spitting reaction, it is possible to overcome the disadvantages of each of metal oxide and perovskite, which have been mainly used as oxygen carrier particles in the above reaction, and to obtain hydrogen/carbon monoxide in high yield based on the high activity and stability of the oxygen carrier particles.

Therefore, in one aspect, the present invention is directed to core-shell structured oxygen carrier particles comprising: a core containing a metal oxide; and a shell containing a perovskite surrounding a part or the whole of the core.

In another aspect, the present invention is directed to a method of preparing the oxygen carrier particles, the method comprising steps of: (a) mixing a metal oxide nanoparticle suspension and a chelate solution containing a perovskite precursor, and drying the mixture; and (b) calcining the dried mixture, followed by cooling and powdering.

In the present invention, the metal oxide refers to an oxidized form of a metal element selected from the group consisting of lanthanides, including cerium, and transition metals, including nickel, cobalt, iron, and the like, and is preferably at least one selected from among these elements.

In addition, in the present invention, the metal oxide may be cerium(IV) oxide (CeO₂), nickel(II) oxide (NiO), tricobalt tetraoxide (Co₃O₄), or iron(III) oxide (Fe₂O₃), without being limited thereto.

The perovskite of the present invention preferably has an ABO₃ structure, wherein A is preferably at least one, more preferably two or more, selected from the group consisting of lanthanum (La), calcium (Ca) and strontium (Sr), and B is at least one selected from among transition metals including manganese (Mn), iron (Fe), nickel (Ni), cobalt (Co), and the like.

In addition, the perovskite may be La_{0.75}Sr_{0.25}FeO₃ or LaFeO₃, without being limited thereto.

The metal oxide-perovskite core-shell structure of the present invention is in a core-shell form in which the above-specified perovskite surrounds the above-specified metal oxide, and is a composition in which the metal oxide is present in the core and the perovskite is present in the shell.

In the present invention, the molar ratio of the metal oxide to the perovskite may be 1:10 to 10:1. If the content of the metal oxide is less than the lower limit of the above range, the synthesized oxygen carrier particles may not have sufficient oxygen-carrying capacity, and thus may not exhibit sufficient activity in the reaction of the present invention. If the content of the perovskite is less than the lower limit of the above range, it may not sufficiently surround the metal oxide, and thus the core-shell structure cannot be perfectly formed, suggesting that the perovskite cannot resolve problems such as low sintering resistance and structural stability of the metal oxide.

In the present invention, the oxygen carrier particles may be expressed as core@shell using the symbol “@”. Specifically, the oxygen carrier particles may be expressed as CeO₂@La_{0.75}Sr_{0.25}FeO₃, NiO@La_{0.75}Sr_{0.25}FeO₃, Fe₂O₃@La_{0.75}Sr_{0.25}FeO₃, Co₃O₄@La_{0.75}Sr_{0.25}FeO₃, Co₃O₄—NiO@La_{0.75}Sr_{0.25}FeO₃ or Fe₂O₃@LaFeO₃, without being limited thereto.

The oxygen carrier particles according to the present invention may be produced by a method of preparing oxygen carrier particles, the method comprising steps of: (a) dissolving metal oxide nanoparticles in a solvent, allowing the solution to stand, and then collecting a nanoparticle suspension of a lower layer resulting from separation of the solution into layers; (b) adding a chelating agent to a perovskite precursor solution to obtain a chelate solution; (c) mixing the nanoparticle suspension of step (a) with the chelate solution of step (b), and drying the mixture; and (d) calcining the dried mixture of step (c) at 450 to 900° C., followed by cooling to room temperature and powdering.

In still another aspect, the present invention is directed to a method of producing hydrogen from water by subjecting water to a chemical-looping thermochemical splitting reaction using a reducing agent and the oxygen carrier particles.

In yet another aspect, the present invention is directed to a method of producing carbon monoxide from carbon dioxide by subjecting carbon dioxide to a chemical-looping thermochemical splitting reaction using a reducing agent and the oxygen carrier particles.

In still yet another aspect, the present invention is directed to a method of producing hydrogen and carbon monoxide from water and carbon dioxide by subjecting water and carbon dioxide to a chemical-looping thermochemical splitting reaction using a reducing agent and the oxygen carrier particles.

In the present invention, hydrogen and carbon monoxide may be produced from water and carbon dioxide by a method comprising steps of: (a) reducing the oxygen carrier particles while generating oxygen vacancies on the surface of the oxygen carrier particles using at least one reducing agent selected from the group consisting of methane, hydrogen and carbon monoxide in a reduction reactor; (b) re-oxidizing the reduced oxygen carrier particles of step (a) by exposure to a water atmosphere in an oxidation reactor to obtain hydrogen; and (c) re-oxidizing the reduced oxygen carrier particles of step (a) by exposure to a carbon dioxide atmosphere in an oxidation reactor to obtain carbon monoxide.

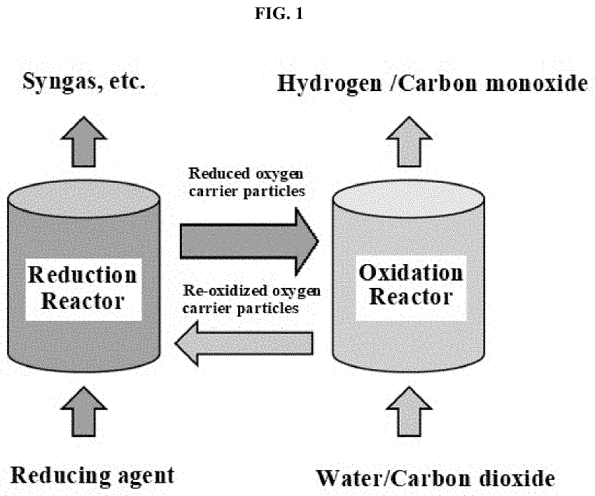

The method of producing hydrogen/carbon monoxide from water/carbon dioxide by a chemical-looping thermochemical splitting reaction according to the present invention will now be described in more detail with reference to FIG. 1.

The “reduction reactor” step is step (a) of reducing the oxygen carrier particles while generating oxygen vacancies on the surface of the oxygen carrier particles using at least one reducing agent selected from the group consisting of methane, hydrogen and carbon monoxide. In step (a), the supplied reducing agent is oxidized and converted into syngas and water, and the oxygen carrier particles having a metal oxide-perovskite core-shell structure, used in the reaction, are reduced.

The “oxidation reactor” step is step (b) of re-oxidizing the reduced oxygen carrier particles of step (a) by exposure to water/carbon dioxide to produce hydrogen/carbon monoxide. In this step, the supplied water/carbon dioxide is converted into hydrogen/carbon monoxide while oxygen present in the water/carbon dioxide regenerates the reduced oxygen carrier particles.

The supplied reducing agent in the “reduction reactor” is a pure gas of each of “methane”, “hydrogen”, and “carbon monoxide” or a mixture of two or more selected from group consisting of these gases. Preferably, the contact time between the reducing agent and the oxygen carrier particles is 0.1 to 1,000 L/g catalyst*hr at an absolute pressure of 0.01 to 100 atm.

The supplied “carbon dioxide” in the “oxidation reactor” is pure carbon dioxide or an exhaust gas containing carbon dioxide.

The supplied “water” in the “oxidation reactor” refers to steam obtained by vaporizing pure water using a steam generator.

In addition, the supplied water/carbon dioxide in the “oxidation reactor” refers to either a pure gas of each of “water” and “carbon dioxide” or a gas mixture thereof. The contact time between water or carbon dioxide and the oxygen carrier particles is preferably 0.1 to 1,000 L/g catalyst*hr at an absolute pressure of 0.01 to 100 atm.

If the pressure of the reactant gas is lower than 0.01 atm, the reactivity thereof may excessively decrease, resulting in reduction in the efficiency of the reaction, and if the pressure of the reactant gas is higher than 100 atm, excessive cost may be incurred to meet the conditions of high pressure at high temperature.

In the present invention, the method may further comprise, after step (b) or after step (c), step (d) of re-oxidizing the oxygen carrier particles with air or an oxygen-containing gas to obtain additionally oxidized oxygen carrier particles.

In the present invention, the contact time between the gas (methane, hydrogen, carbon monoxide, water, or carbon dioxide), which is supplied to the chemical-looping thermochemical water/carbon dioxide splitting reaction, and the oxygen carrier particles, is preferably 0.1 to 1,000 L/g catalyst*hr, which means a value obtained by dividing the flow rate of the supplied gas by the mass of the oxygen carrier particles. If the contact time is shorter than the lower limit of the above range, it may be inefficient because it requires an excessively large amount of the catalyst or a long reaction time, and if the contact time is longer than the corresponding range, the contact time between the reducing agent or water/carbon dioxide and the oxygen carrier particles is excessively short, and thus the production efficiency of hydrogen/carbon monoxide may decrease.

In the present invention, the reaction temperature is 100 to 1,200° C., more preferably 500 to 700° C., and after the reaction temperature is reached, the reaction time for each step is preferably 0.1 minutes to 2 hours. If the reaction temperature is lower than 100° C., the production efficiency may excessively decrease due to low reactivity, and if the reaction temperature is higher than 1,200° C., it is inefficient because excessively high energy consumption and cost may be required to maintain the high temperature. In addition, if the reaction time for each step is shorter than the lower limit of the above range, the contact time between the reactant gas and the particles will be short, and thus the production efficiency of hydrogen/carbon monoxide may decrease, and if the reaction time for each step is longer than the upper limit of the above range, the performance of the particles may be degraded due to inactivation thereof.

In the present invention, in step (a) of reducing the oxygen carrier particles having a metal oxide-perovskite core-shell structure while generating oxygen vacancies on the surface of the oxygen carrier particles using at least one reducing agent selected from the group consisting of methane, hydrogen and carbon monoxide, syngas (hydrogen, carbon monoxide, or carbon dioxide) and water (steam) may be produced, and the production rate of each gas may vary depending on the reaction temperature and reaction time.

Hereinafter, the present invention will be described in more detail with reference to examples in order to help the understanding of the present invention, but the following examples are only illustrative of the present invention, and it will be obvious to those skilled in the art that various changes and modifications are possible without departing from the scope and technical spirit of the present invention. In addition, naturally, these changes and modifications fall within the scope of the appended claims.

### EXAMPLES

### Example 1

### Production of Oxygen Carrier Particles Having Metal Oxide-Perovskite Core-Shell Structure

### Example 1-1

### Production of Oxygen Carrier Particles 1-1 (CeO₂@La_{0.75}Sr_{0.25}FeO₃)

A production method performed to produce oxygen carrier particles (CeO₂@La_{0.75}Sr_{0.25}FeO₃) having a core-shell structure will now be described.

1) 0.6888 g (4 mmol) of cerium(IV) oxide (CeO₂) nanoparticles (<50 nm, Sigma-Aldrich) and 20 mL of a 60 vol % aqueous ethanol solution (8 mL of distilled water+12 mL of ethanol) were placed in a 50 mL vial and then stirred at room temperature for 5 minutes.

2) The stirred solution was left to stand for 12 hours or more so that layer separation between the nanoparticles and the aqueous ethanol solution occurred.

3) After layer separation occurred, the aqueous ethanol solution of the upper layer was discarded and a nanoparticle suspension of the lower layer was collected. At this time, when the liquid in the upper layer did not have a transparent color, which is the color of a conventional aqueous ethanol solution, an additional process may be performed by placing the liquid in a conical tube, centrifuging the liquid in a centrifuge at 10,000 rpm for 30 minutes to separate the liquid into the ethanol aqueous solution and the nanoparticles, and then discarding the aqueous ethanol solution and collecting the nanoparticles.

4) 1.3003 g (3 mmol) of lanthanum nitrate hydrate (La(NO₃)₃.6H₂O, 99.9%, Alfa Aesar), 0.2693 g (1 mmol) of strontium chloride hexahydrate (SrCl₂.6H₂O, 99%, Sigma-Aldrich), and 1.6490 g (4 mmol) of iron nitrate hydrate (Fe(NO₃)₃.9H₂O, >98%, Sigma-Aldrich), as perovskite precursors, and 20 mL of distilled water were placed in a 250 mL lab bottle, and then the precursors were dissolved while stirring at a speed of 300 rpm for 30 min at 50° C. to obtain a precursor solution.

5) After completion of process 4), 4.6341 g (24 mmol) of citric acid (>99.5%, Sigma-Aldrich) was added to the precursor solution, followed by stirring at a speed of 300 rpm for 30 min at 50° C. to obtain a chelate solution.

6) The nanoparticle suspension of process 3) and the chelate solution of process 5) were mixed together in a suitable amount of distilled water, and the mixture was stirred at a speed of 300 rpm for 30 min at 50° C.

7) 2.71 mL (48 mmol) of ethylene glycol (99.5%, Samchun Pure Chemical Co.) was added to the solution of process 6), and then the lid of the lab bottle was opened, and the resulting solution was dried by stirring at a speed of 300 rpm for 12 hours or more at 80 to 100° C. Finally, stirring was stopped and drying was performed at 130° C. for 6 hours or more.

8) The dried sample was placed in an alumina crucible which was then placed in a reactor (furnace) in which the sample was calcined while air (>99.999%, Samo Gas) was supplied at a flow rate of 80 mL/min. At this time, the temperature of the reactor was raised from 20° C. to 450° C. at a rate of 5° C./min and maintained at that temperature for 4 hours, and then raised again from 450° C. to 900° C. at a rate of 5° C./min and maintained at that temperature for 6 hours. After completion of the calcination process, the sample was cooled to room temperature and powdered using a mortar and pestle, thereby producing oxygen carrier particles 1-1.

### Example 1-2

### Production of Oxygen Carrier Particles 1-2 (NiO@La_{0.75}Sr_{0.25}FeO₃)

Oxygen carrier particles 1-2 having a metal oxide-perovskite core-shell structure were produced in the same manner as in Example 1-1, except that 0.2994 g (4 mmol) of nickel(II) oxide (NiO) nanoparticles (<50 nm, Sigma-Aldrich) were used instead of 0.6888 g (4 mmol) of cerium(IV) oxide (CeO₂) nanoparticles (<50 nm, Sigma-Aldrich).

### Example 1-3

### Production of Oxygen Carrier Particles 1-3 (Fe₂O₃@La_{0.75}Sr_{0.25}FeO₃)

Oxygen carrier particles 1-3 having a metal oxide-perovskite core-shell structure were produced in the same manner as in Example 1-1, except that 0.6388 g (4 mmol) of iron(III) oxide (Fe₂O₃) nanoparticles (<50 nm, Sigma-Aldrich) were used instead of 0.6888 g (4 mmol) of cerium(IV) oxide (CeO₂) nanoparticles (<50 nm, Sigma-Aldrich).

### Example 1-4

### Production of Oxygen Carrier Particles 1-4 (Co₃O₄@La_{0.75}Sr_{0.25}FeO₃)

Oxygen carrier particles 1-4 having a metal oxide-perovskite core-shell structure were produced in the same manner as in Example 1-1, except that 0.9680 g (4 mmol) of tricobalt tetraoxide (Co₃O₄) nanoparticles (<50 nm, Sigma-Aldrich) were used instead of 0.6888 g (4 mmol) of cerium(IV) oxide (CeO₂) nanoparticles (<50 nm, Sigma-Aldrich), and that the final calcining temperature was lowered from 900° C. to 800° C. In this case, the reason why the calcining temperature was adjusted to 800° C. is that tricobalt tetraoxide is decomposed (Co₃O₄↔3CoO+O₂) at a temperature of 900° C. or higher to form cobalt(II) oxide. If the same situation occurs when using any metal oxide as well as tricobalt tetraoxide, the calcining temperature may be adjusted.

### Example 1-5

### Production of Oxygen Carrier Particles 1-5 (Co₃O₄—NiO@La_{0.75}Sr_{0.25}FeO₃)

Oxygen carrier particles 1-5 having a metal oxide-perovskite core-shell structure were produced in the same manner as in Example 1-4, except that 0.4840 g (2 mmol) of tricobalt tetraoxide (Co₃O₄) nanoparticles (<50 nm, Sigma-Aldrich) and 0.1494 g (2 mmol) of nickel(II) oxide (NiO) nanoparticles (<50 nm, Sigma-Aldrich) were used instead of 0.9680 g (4 mmol) of tricobalt tetraoxide (Co₃O₄) nanoparticles (<50 nm, Sigma-Aldrich).

### Example 1-6

### Production of Oxygen Carrier Particles 1-6 (Fe₂O₃@LaFeO₃)

A production method performed to produce oxygen carrier particles (Fe₂O₃@LaFeO₃) having a core-shell structure will now be described.

1) 0.6388 g (4 mmol) of iron(III) oxide (Fe₂O₃) nanoparticles (<50 nm, Sigma-Aldrich) and 20 mL of a 60 vol % aqueous ethanol solution (8 mL of distilled water+12 mL of ethanol) were placed in a 50 mL vial and then stirred at room temperature for 5 minutes.

2) The stirred solution was left to stand for 12 hours or more so that layer separation between the nanoparticles and the aqueous ethanol solution occurred.

3) After the layer separation occurred, the aqueous ethanol solution of the upper layer was discarded and a nanoparticle suspension of the lower layer was collected. At this time, when the liquid in the upper layer did not have a transparent color, which is the color of a conventional aqueous ethanol solution, an additional process may be performed by placing the liquid in a conical tube, centrifuging the liquid in a centrifuge at 10,000 rpm for 30 minutes to separate the liquid into the aqueous ethanol solution and the nanoparticles, and then discarding the aqueous ethanol solution and collecting the nanoparticles.

4) 0.1926 g (0.45 mmol) of lanthanum nitrate hydrate (La(NO₃)₃.6H₂O, 99.9%, Alfa Aesar) and 0.1832 g(0.45 mmol) of iron nitrate hydrate (Fe(NO₃)₃.9H₂O, >98%, Sigma-Aldrich), as perovskite precursors, and 20 mL of distilled water were placed in a 250 mL lab bottle, and then the precursors were dissolved by stirring at a speed of 300 rpm for 30 min at 50° C. to obtain a precursor solution.

5) After completion of process 4), 0.5149 g (2.68 mmol) of citric acid (>99.5%, Sigma-Aldrich) was added to the precursor solution, followed by stirring at a speed of 300 rpm for 30 min at 50° C. to obtain a chelate solution.

6) The nanoparticle suspension of process 3) and the chelate solution of process 5) were mixed together in a suitable amount of distilled water, and the mixture was stirred at a speed of 300 rpm for 30 min at 50° C.

7) 0.30 mL (5.39 mmol) of ethylene glycol (99.5%, Samchun Pure Chemical Co.) was added to the solution of process 6), and then the lid of the lab bottle was opened, and the resulting solution was dried by stirring at a speed of 300 rpm for 12 hours or more at 80 to 100° C. Finally, stirring was stopped and drying was performed at 130° C. for 6 hours or more.

The dried sample was placed in an alumina crucible which was then placed in a reactor (furnace) in which the sample was calcined while air (>99.999%, Samo Gas) was supplied at a flow rate of 80 mL/min. At this time, the temperature of the reactor was raised from 20° C. to 450° C. at a rate of 5° C./min and maintained at that temperature for 4 hours, and then raised again from 450° C. to 900° C. at a rate of 5° C./min and maintained at that temperature for 6 hours. After completion of the calcination process, the sample was cooled to room temperature and powdered using a mortar and pestle, thereby producing oxygen carrier particles 1-6.

### Example 2

### Structural Analysis of Produced Oxygen Carrier Particles

Analysis methods for analyzing the structures of the oxygen carrier particles produced in Example 1 will now be described.

### Example 2-1

### XRD Analysis

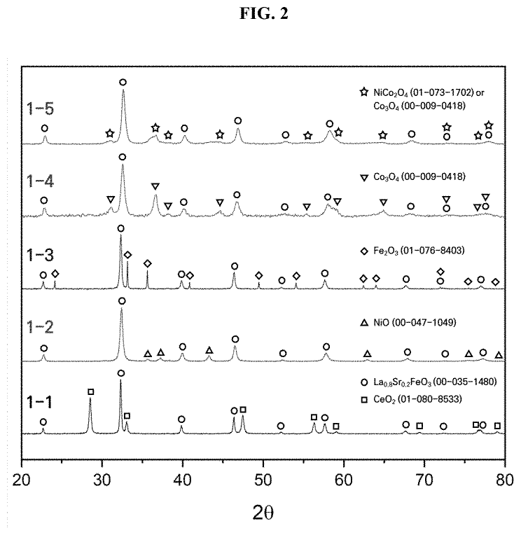

X-ray diffraction (XRD) analysis was performed on the oxygen carrier particles 1-1 to 1-5 produced in Examples 1-1 to 1-5, and the results are shown in FIG. 2. In this case, X-ray powder analysis was performed using an X-ray diffraction spectrometer (Rigaku SmartLab).

Referring to FIG. 2, it could be confirmed that the oxygen carrier particles 1-1 to 1-5 produced in Examples 1-1 to 1-5 commonly had a phase (PDF CARD: 00-035-1480) corresponding to La_{0.8}Sr_{0.2}FeO₃, which is a perovskite (PDF CARD: 00-035-1480), and also had other phases corresponding to each metal oxide. More specifically, it could be confirmed that oxygen carrier particles 1-1 had a phase corresponding to CeO₂ (PDF CARD: 01-080-8533), 1-2 had a phase corresponding to NiO (PDF CARD: 00-047-1049), 1-3 had a phase corresponding to Fe₂O₃ (PDF CARD: 01-076-8403), 1-4 had a phase corresponding to Co₃O₄ (PDF CARD: 00-009-0418), and 1-5 had a phase corresponding to NiCo₂O₄ (PDF CARD: 01-073-1702) or Co₃O₄ (PDF CARD: 00-009-0418). Thus, it could be confirmed that each oxygen carrier particle must have the intended phase during production, and did not have other unnecessary phases.

### Example 2-2

### ICP-MS Analysis

Inductively coupled plasma mass spectroscopy (ICP-MS) was performed on the oxygen carrier particles 1-1 to 1-5 produced in Examples 1-1 to 1-5, and the results are shown in Table 1 and Table 2 below. In this case, the analysis was performed using an inductively coupled plasma mass spectrometer (Agilent ICP-MS 7700S).

Table 1 and Table 2 relate to the proportion of each element when the molar ratio of metal oxide: perovskite in each of Examples 1-1 to 1-5 was 1:1. First, Table 1 shows the result of calculating the ideal proportion of each element in each oxygen carrier particle, and Table 2 shows the result of measuring the actual proportion of each element in each oxygen carrier particle by inductively coupled plasma mass spectrometry. Comparing Table 1 with Table 2, it can be seen that there is no significant difference between the ideal proportion and the actual proportion, suggesting that each metal oxide and perovskite were used at an appropriate ratio.

TABLE 1

| | Element proportion (atomic %) | | | | | |
|---|---|---|---|---|---|---|
| Oxygen carrier particles | Fe | Co | Ni | Sr | La | Ce |
| Oxygen carrier particles 1-1 | 33.33 | 0 | 0 | 8.33 | 25 | 33.33 |
| Oxygen carrier particles 1-2 | 33.33 | 0 | 33.33 | 8.33 | 25 | 0 |
| Oxygen carrier particles 1-3 | 75 | 0 | 0 | 6.25 | 18.75 | 0 |
| Oxygen carrier particles 1-4 | 20 | 60 | 0 | 5 | 15 | 0 |
| Oxygen carrier particles 1-5 | 25 | 37.5 | 12.5 | 6.25 | 18.75 | 0 |

TABLE 2

| | Element proportion (atomic %) | | | | | |
|---|---|---|---|---|---|---|
| Oxygen carrier particles | Fe | Co | Ni | Sr | La | Ce |
| Oxygen carrier particles 1-1 | 35.31 | 0 | 0 | 8.65 | 25.24 | 30.8 |
| Oxygen carrier particles 1-2 | 35.51 | 0 | 30.64 | 8.73 | 25.11 | 0 |
| Oxygen carrier particles 1-3 | 73.3 | 0 | 0 | 6.83 | 19.87 | 0 |
| Oxygen carrier particles 1-4 | 21.55 | 58.01 | 0 | 5.25 | 15.19 | 0 |
| Oxygen carrier particles 1-5 | 22.86 | 38.03 | 15.1 | 5.94 | 18.07 | 0 |

### Example 2-3

### XPS Analysis

X-ray photoelectron spectroscopy (XPS) was performed on the oxygen carrier particles 1-1 to 1-5 produced in Examples 1-1 to 1-5, and the results are shown in Table 3 below. In this case, the analysis was performed using an X-ray photoelectron spectrometer (Thermo VG Scientific K-alpha).

Table 3 shows the results of measuring the proportion of each element on the surface of each oxygen carrier particle (produced in each of Examples 1-1 to 1-5) by X-ray photoelectron spectroscopy. Comparing the results shown in Table 3 with the results shown in Table 2, it is possible to compare the proportion of each element distributed through the oxygen carrier particle with the proportion of each element distributed on the surface. In comparison, the proportion of the core metal (metal present on the metal oxide; Ce for 1-1, Ni for 1-2, etc.) present on the surface of each oxygen carrier particle is only less than half the proportion of the corresponding metal distributed throughout the oxygen carrier particle. Thus, it can be confirmed that the oxygen carrier particles produced in Example 1 have a core-shell structure in which the metal oxide is located in the core and the perovskite is located in the shell.

TABLE 3

| | Element proportion (atomic %) | | | | | |
|---|---|---|---|---|---|---|
| Oxygen carrier particles | Fe | Co | Ni | Sr | La | Ce |
| Oxygen carrier particles 1-1 | 23.26 | 0 | 0 | 32.4 | 27.15 | 17.2 |
| Oxygen carrier particles 1-2 | 24.96 | 0 | 13.45 | 29.1 | 32.48 | 0 |
| Oxygen carrier particles 1-3 | 37.71 | 0 | 0 | 23.38 | 33.91 | 0 |
| Oxygen carrier particles 1-4 | 22.46 | 23.18 | 0 | 27.9 | 26.46 | 0 |
| Oxygen carrier particles 1-5 | 17.21 | 20.73 | 8.03 | 25.15 | 28.88 | 0 |

### Example 3

### Analysis of Temperature-Dependent Reactivity Tendency of Produced Oxygen Carrier Particles

Analysis methods for analyzing the oxidation/reduction properties and reactivity tendency of the oxygen carrier particles produced in Example 1 will now be described.

### Example 3-1

### H₂-TPR Analysis

H₂-temperature programmed reduction (H₂-TPR) analysis was performed on the oxygen carrier particles 1-1 to 1-5 produced in Examples 1-1 to 1-5 and a control (perovskite, La_{0.75}Sr_{0.25}FeO₃). Regarding analytical instruments and conditions, 0.1 g of the oxygen carrier particles produced in each Example were packed in a fixed-bed glass reactor having a diameter of 7 mm, and 10 mL/min of hydrogen and 40 mL/min of nitrogen were continuously supplied to the reactor. Then, using an electric furnace, the temperature of the reactor was raised from 20° C. to 900° C. at a rate of 5° C./min and maintained at 900° C. for 30 min. In this case, the amount of unreacted hydrogen was measured using a thermal conductivity gas analyzer (Fuji Electric System, ZAF-4), and the amount of consumed hydrogen was calculated.

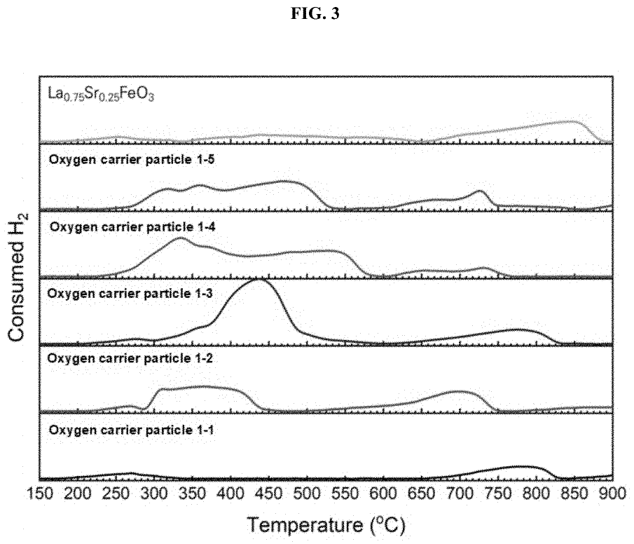

FIG. 3 shows the amount of consumed hydrogen as a function of temperature for each oxygen carrier particle obtained through the experiment, and Table 4 below shows the values obtained by calculating the amount of consumed hydrogen. Referring to FIG. 3 and Table 4, it could be confirmed that the control (perovskite) showed a high consumption of hydrogen at a high temperature of 800° C. or higher, whereas most of the oxygen carrier particles having a metal oxide-perovskite core-shell structure showed a high consumption of hydrogen at a temperature below 600° C., which is a relatively low temperature. Thereby, it could be confirmed that the oxygen carrier particles having a metal oxide-perovskite core-shell structure had a high oxygen-carrying capacity even at a relatively low temperature.

TABLE 4

| Consumed hydrogen | Type of oxygen carrier particle | | | | | |
|---|---|---|---|---|---|---|
| amount (mmol/g) | 1-1 | 1-2 | 1-3 | 1-4 | 1-5 | Control |
| Till 600° C. | 0.47 | 3.79 | 7.38 | 8.18 | 5.68 | 1.75 |
| Till 900° C. | 1.86 | 6.14 | 9.17 | 9.06 | 7.42 | 4.72 |

### Example 3-2

### CO₂-TPO Analysis

CO₂-temperature programmed oxidation (CO₂-TPO) analysis was performed on the oxygen carrier particles 1-1 to 1-5 produced in Examples 1-1 to 1-5 and the control (perovskite, La0.75Sr0.25FeO₃). In this case, the produced oxygen carrier particles were reduced using hydrogen, and then the temperature was raised while carbon dioxide was supplied. Regarding analytical instruments and conditions, 0.1 g of the oxygen carrier particles produced in each Example were packed in a fixed-bed glass reactor having a diameter of 7 mm, and 10 mL/min of hydrogen and 40 mL/min of nitrogen were continuously supplied to the reactor. Then, using an electric furnace, the temperature of the reactor was raised from 20° C. to 600° C. at a rate of 5° C./min, maintained at 600° C. for 30 minutes, cooled to room temperature, and then hydrogen supply was stopped, thereby completing the reduction process. After completion of the reduction process, 10 mL/min of carbon dioxide and 40 mL/min of nitrogen were continuously supplied to the reactor. Then, in the same manner as above, the temperature of the reactor was raised from 20° C. to 900° C. at a rate of 5° C./min and maintained at 900° C. for 30 minutes. In this case, the amounts of unreacted carbon dioxide and generated carbon monoxide was measured using an infrared gas analyzer (Fuji Electric System, ZRJ-6), and the amount of carbon monoxide generated was calculated.

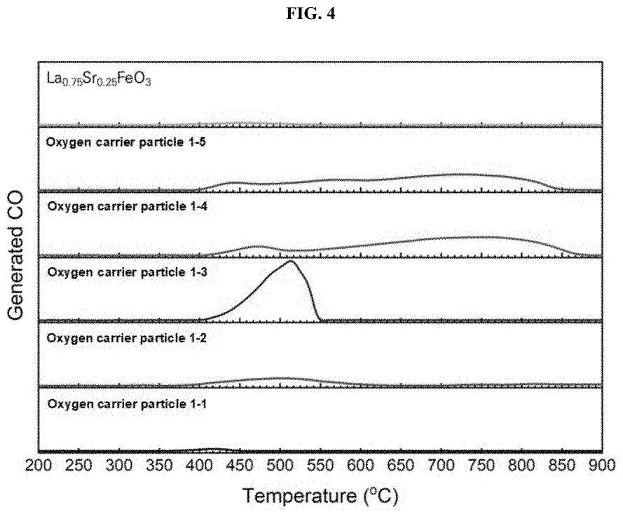

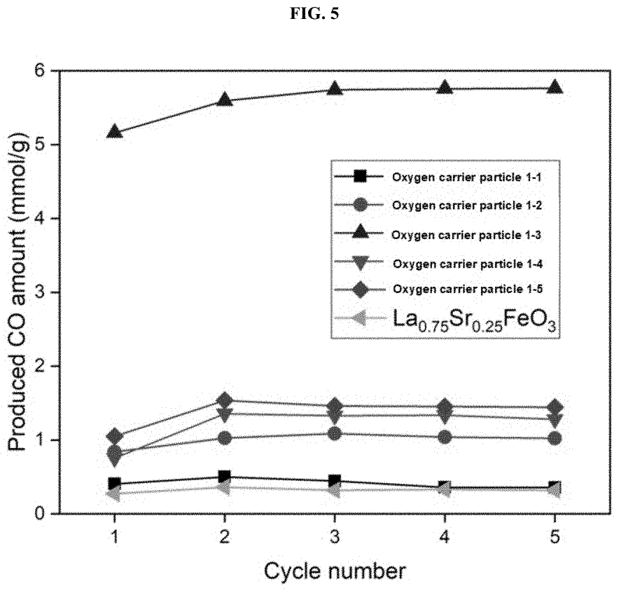

FIG. 5 shows the amount of generated carbon monoxide as a function of temperature for each oxygen carrier particle obtained through the experiment, and Table 5 below shows the values obtained by calculating the amount of generated carbon monoxide. Referring to FIG. 4 and Table 5, most of the oxygen carrier particles having a metal oxide-perovskite core-shell structure showed a higher amount of generated carbon monoxide than the control perovskite, and in particular, oxygen carrier particles 1-3 showed a 19.3-fold higher amount of generated carbon monoxide than the control. Thereby, it could be confirmed that the oxygen carrier particles having a metal oxide-perovskite core-shell structure underwent not only a smooth reduction process but also a smooth re-oxidation process, and thus splitting of the gaseous oxide actively occurred.

TABLE 5

| Generated carbon | | | | | | |
|---|---|---|---|---|---|---|
| monoxide amount | Type of oxygen carrier particle | | | | | |
| (mmol/g) | 1-1 | 1-2 | 1-3 | 1-4 | 1-5 | Control |
| Till 600° C. | 0.10 | 1.16 | 4.88 | 1.35 | 1.72 | 0.25 |
| Till 900° C. | 0.10 | 1.45 | 5.02 | 5.70 | 5.20 | 0.26 |

### Example 4

### Production of Carbon Monoxide from Carbon Dioxide Using Chemical-Looping Thermochemical Process

A method of producing carbon monoxide from carbon dioxide by a chemical-looping thermochemical process and the amount of carbon monoxide produced using the oxygen carrier particles produced in Example 1 or the conventional perovskite will now be described.

### Example 4-1

### Experiment Using Oxygen Carrier Particles 1-1 (CeO-₂@La_{0.75}Sr_{0.25}FeO₃)

Carbon monoxide was produced from carbon dioxide by a chemical-looping thermochemical process using the oxygen carrier particles 1-1 produced in Example 1-1, and the amount of produced carbon monoxide is shown in FIG. 5. In this case, 0.1 g of oxygen carrier particles 1-1 was packed in a fixed-bed glass reactor having a diameter of 7 mm, and using an electric furnace, the temperature of the reactor was raised from 20° C. to 600° C. at a rate of 5° C./min and maintained at 600° C. Thereafter, an oxidation/reduction cycle consisting of a) to d) as follows was performed five times, and the amount of carbon monoxide produced was measured using an infrared gas analyzer and calculated: a) a reduction process of generating oxygen vacancies on the surface of the oxygen carrier particles by supplying 5 mL/min of a reducing agent (hydrogen) and 45 mL/min of nitrogen for 20 minutes; b) a process of purging for 10 minutes by supplying 45 mL/min of nitrogen; c) an oxidation process of generating carbon monoxide while re-oxidizing the oxygen carrier particles by supplying 5 mL/min of carbon dioxide and 45 mL/min of nitrogen for 20 minutes; and d) a process of purging for 10 minutes by supplying 45 mL/min of nitrogen.

### Example 4-2

### Experiment Using Oxygen Carrier Particles 1-2 (NiO@La_{0.75}Sr_{0.25}FeO₃)

Carbon monoxide was produced from carbon dioxide by a chemical-looping thermochemical process using the oxygen carrier particles 1-2 produced in Example 1-2, and the amount of produced carbon monoxide is shown in FIG. 5. In this case, the analysis method and conditions were the same as in Example 4-1, except that oxygen carrier particles 1-2 were used instead of oxygen carrier particles 1-1.

### Example 4-3

### Experiment Using Oxygen Carrier Particles 1-3 (Fe₂O-₃@La_{0.75}Sr_{0.25}FeO₃)

Carbon monoxide was produced from carbon dioxide by a chemical-looping thermochemical process using the oxygen carrier particles 1-3 produced in Example 1-3, and the amount of produced carbon monoxide is shown in FIG. 5. In this case, the analysis method and conditions were the same as in Example 4-1, except that oxygen carrier particles 1-3 were used instead of oxygen carrier particles 1-1.

### Example 4-4

### Experiment Using Oxygen Carrier Particles 1-4 (Co₃O₄@La_{0.75}Sr_{0.25}FeO₃)

Carbon monoxide was produced from carbon dioxide by a chemical-looping thermochemical process using the oxygen carrier particles 1-4 produced in Example 1-4, and the amount of produced carbon monoxide is shown in FIG. 5. In this case, the analysis method and conditions were the same as in Example 4-1, except that oxygen carrier particles 1-4 were used instead of oxygen carrier particles 1-1.

### Example 4-5

### Experiment Using Oxygen Carrier Particles 1-5 (Co₃O₄—NiO@La_{0.75}Sr_{0.25}FeO₃)

Carbon monoxide was produced from carbon dioxide by a chemical-looping thermochemical process using the oxygen carrier particles 1-5 produced in Example 1-5, and the amount of produced carbon monoxide is shown in FIG. 5. In this case, the analysis method and conditions were the same as in Example 4-1, except that oxygen carrier particles 1-5 were used instead of oxygen carrier particles 1-1.

### Comparative Example

### Experiment Using Perovskite (La_{0.75}Sr_{0.25}FeO₃)

In the experiment of producing carbon monoxide from carbon dioxide by the chemical-looping thermochemical process, in order to compare the carbon monoxide production efficiency of the oxygen carrier particles produced in each of Examples 1-1 to 1-5 with that of a perovskite used in a conventional art (Y. A. Daza, et al., Catalysis Today, 258, 691-698 (2015)), carbon monoxide was produced from carbon dioxide by a chemical-looping thermochemical process using a perovskite (La_{0.75}Sr_{0.25}FeO₃) constituting the shell of each of oxygen carrier particles 1-1 to 1-5, and the amount of produced carbon monoxide is shown in FIG. 5. In this case, the analysis method and conditions were the same as in Example 4-1, except that the perovskite (La_{0.75}Sr_{0.25}FeO₃) was used instead of oxygen carrier particles 1-1.

In order to compare the results of Examples 4-1 to 4-5 and the Comparative Example, the amount of carbon monoxide produced using each oxygen carrier particle is summarized in Table 6 below. Referring to Table 6, it could be confirmed that the oxygen carrier particles having a metal oxide-perovskite core-shell structure showed an at least 1.3-fold (oxygen carrier particles 1-1) to at most 17.5-fold (oxygen carrier particles 1-3) higher amount of carbon monoxide production than the conventional perovskite.

TABLE 6

| | Produced CO amount (mmol/g) | | | | | |
|---|---|---|---|---|---|---|
| Oxygen carrier | depending on cycle number | | | | | |
| particles | 1 | 2 | 3 | 4 | 5 | Average |
| Oxygen carrier | 0.41 | 0.50 | 0.44 | 0.36 | 0.36 | 0.41 |
| particles 1-1 | | | | | | |
| Oxygen carrier | 0.84 | 1.03 | 1.09 | 1.04 | 1.02 | 1.00 |
| particles 1-2 | | | | | | |
| Oxygen carrier | 5.16 | 5.59 | 5.74 | 5.76 | 5.76 | 5.60 |
| particles 1-3 | | | | | | |
| Oxygen carrier | 0.75 | 1.36 | 1.33 | 1.34 | 1.28 | 1.21 |
| particles 1-4 | | | | | | |
| Oxygen carrier | 1.05 | 1.54 | 1.46 | 1.45 | 1.44 | 1.39 |
| particles 1-5 | | | | | | |
| La_{0.75}Sr_{0.25}FeO₃ | 0.27 | 0.36 | 0.32 | 0.33 | 0.32 | 0.32 |

### Example 4-6

### Experiment Using Oxygen Carrier Particles 1-6 (Fe₂O₃@LaFeO₃)

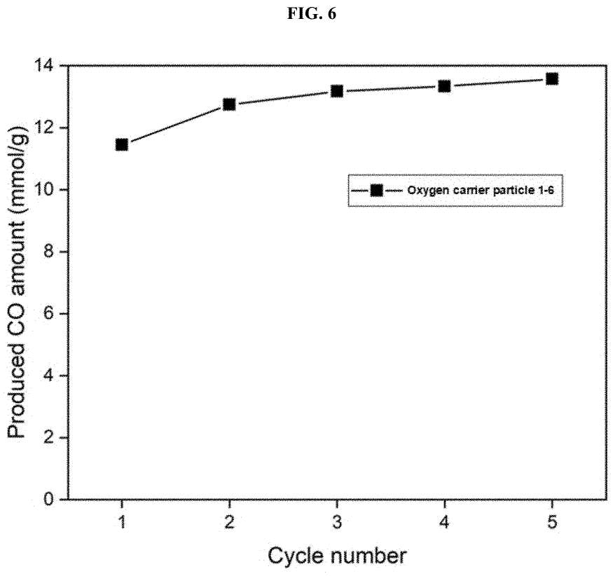

Carbon monoxide was produced from carbon dioxide by a chemical-looping thermochemical process using the oxygen carrier particles 1-6 produced in Example 1-6, and the amount of produced carbon monoxide is shown in FIG. 6. In this case, 0.1 g of oxygen carrier particles 1-6 was packed in a fixed-bed glass reactor having a diameter of 7 mm, and using an electric furnace, the temperature of the reactor was raised from 20° C. to 477° C. at a rate of 5° C./min and maintained at 477° C. Thereafter, an oxidation/reduction cycle consisting of a) to d) as follows was performed five times, and the amount of carbon monoxide produced was measured using an infrared gas analyzer and calculated: a) a reduction process of generating oxygen vacancies on the surface of the oxygen carrier particles by supplying 10 mL/min of a reducing agent (hydrogen) and 40 mL/min of nitrogen for 20 minutes; b) a process of purging for 10 minutes by supplying 40 mL/min of nitrogen; c) an oxidation process of generating carbon monoxide while re-oxidizing the oxygen carrier particles by supplying 10 mL/min of carbon dioxide and 40 mL/min of nitrogen for 20 minutes; and d) a process of purging for 10 minutes by supplying 40 mL/min of nitrogen.

### Example 5

### Long-Term Stability Test for Oxygen Carrier Particles in Production of Carbon Monoxide from Carbon Dioxide by Chemical-Looping Thermochemical Process

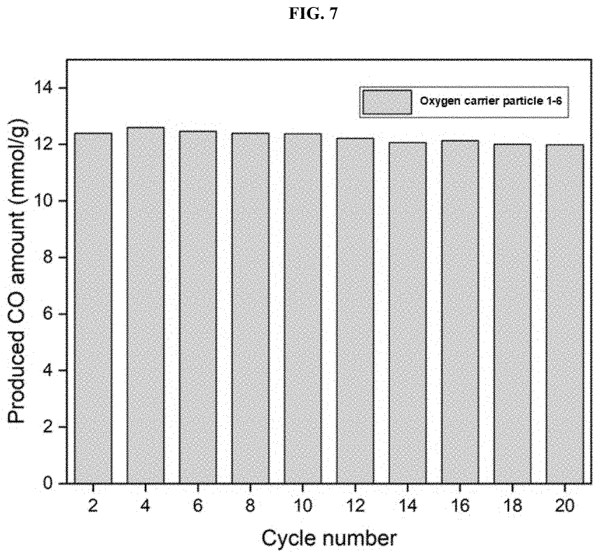

In this Example, the long-term stability of oxygen carrier particles 1-6, which showed the highest amount of carbon monoxide production in the production of carbon monoxide from carbon dioxide in a medium circulation thermochemical process, was tested, and the amount of carbon monoxide produced using oxygen carrier particles 1-6 is shown in FIG. 7. In this case, the analysis method and conditions were the same as in Example 4-6, except that the oxidation/reduction cycle was performed 20 times instead of 5 times.

Referring to FIG. 7, it could be seen that oxygen carrier particles 1-6 stably produced about 12 mmol/g of carbon monoxide per cycle during 20 oxidation/reduction cycles, suggesting that the oxygen carrier particles having a metal oxide-perovskite core-shell structure have thermal and structural stability in the chemical-looping thermochemical process.

### Example 6

### Production of Hydrogen from Water (Steam) Using Chemical-Looping Thermochemical Process

A method of producing hydrogen from water (steam) by a chemical-looping thermochemical process and the amount of hydrogen produced using the oxygen carrier particles produced in each of Examples 1-3 and 1-6 will now be described.

### Example 6-1

### Experiment Using Oxygen Carrier Particles 1-3 (Fe₂O₃@La_{0.75}Sr_{0.25}FeO₃)

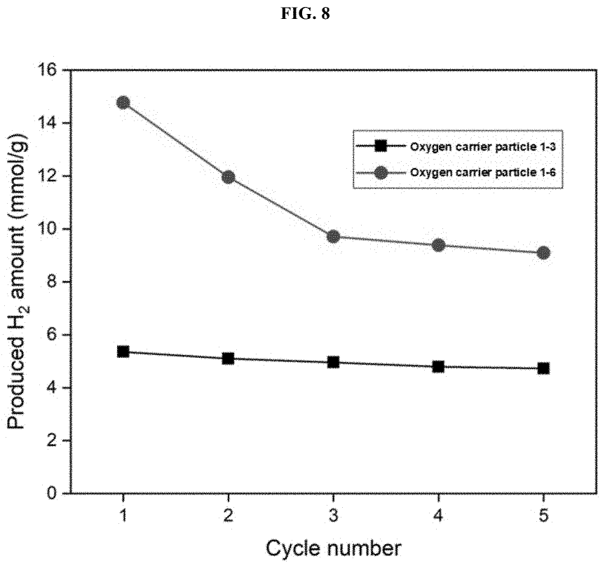

Hydrogen was produced from water (steam) by a chemical-looping thermochemical process using the oxygen carrier particles 1-3 produced in Example 1-3, and the amount of produced hydrogen is shown in FIG. 8. In this case, 0.15 g of oxygen carrier particles 1-3 was packed in a fixed-bed glass reactor having a diameter of 7 mm, and using an electric furnace, the temperature of the reactor was raised from 20° C. to 530° C. at a rate of 5° C./min and maintained at 530° C. Regarding steam supply, liquid water was supplied at a certain flow rate by a syringe pump (ISCO Model 100DM Syringe Pump), and the supplied water was vaporized into steam by being introduced into a steam generator heated to 270° C., and then the steam was maintained above 150° C. by a heat wire and introduced into the reactor. Thereafter, an oxidation/reduction cycle consisting of a) to d) as follows was performed five times, and the amount of hydrogen produced was measured using a thermal conductivity gas analyzer and calculated: a) a reduction process of generating oxygen vacancies on the surface of the oxygen carrier particles by supplying 5 mL/min of a reducing agent (carbon monoxide) and 45 mL/min of nitrogen for 20 minutes; b) a process of purging for 10 minutes by supplying 45 mL/min of nitrogen; c) an oxidation process of generating hydrogen while re-oxidizing the oxygen carrier particles by supplying 0.01 mL/min of liquid-state water and 45 mL/min of nitrogen for 20 minutes; and d) a process of purging for 10 minutes by supplying 45 mL/min of nitrogen.

### Example 6-2

### Experiment Using Oxygen Carrier Particles 1-6 (Fe₂O₃@LaFeO₃)

Hydrogen was produced from water (steam) by a chemical-looping thermochemical process using the oxygen carrier particles 1-6 produced in Example 1-6, and the amount of produced hydrogen is shown in FIG. 8. In this case, 0.1 g of oxygen carrier particles 1-6 was packed in a fixed-bed glass reactor having a diameter of 7 mm, and using an electric furnace, the temperature of the reactor was raised from 20° C. to 477° C. at a rate of 5° C./min and maintained at 477° C. Regarding steam supply, liquid-state water at a certain flow rate was supplied by a syringe pump (ISCO Model 100DM Syringe Pump), and the supplied water was vaporized into steam by being introduced into a steam generator heated to 270° C., and then the steam was maintained above 150° C. by a heating wire and introduced into the reactor. Thereafter, an oxidation/reduction cycle consisting of a) to d) as follows was performed five times, and the amount of hydrogen produced was measured using a thermal conductivity gas analyzer and calculated: a) a reduction process of generating oxygen vacancies on the surface of the oxygen carrier particles by supplying 10 mL/min of a reducing agent (carbon monoxide) and 40 mL/min of nitrogen for 20 minutes; b) a process of purging for 10 minutes by supplying 40 mL/min of nitrogen; c) an oxidation process of generating hydrogen while re-oxidizing the oxygen carrier particles by supplying 0.02 mL/min of liquid water and 40 mL/min of nitrogen for 20 minutes; and d) a process of purging for 10 minutes by supplying 40 mL/min of nitrogen.

Referring to FIG. 8, it could be confirmed that oxygen carrier particles 1-3 stably produced about 4.7 to 5.3 mmol/g of hydrogen per cycle during 5 oxidation/reduction cycles, and oxygen carrier particles 1-6 produced about 9 to 14 mmol/g of hydrogen per cycle, suggesting that the oxygen carrier particles having a metal oxide-perovskite core-shell structure exhibit high efficiency not only in the chemical-looping thermochemical carbon dioxide splitting process, but also in the chemical-looping thermochemical water splitting process.

Although the present invention has been described in detail with reference to specific features, it will be apparent to those skilled in the art that this description is only of a preferred embodiment thereof, and does not limit the scope of the present invention. Thus, the substantial scope of the present invention will be defined by the appended claims and equivalents thereto.

1. Core-shell structured oxygen carrier particles comprising: a core containing a metal oxide; and a perovskite-containing shell surrounding a part or a whole of the core.

2. The oxygen carrier particles of claim 1, wherein the metal oxide is an oxide of at least one metal element selected from the group consisting of lanthanides and transition metals.

3. The oxygen carrier particles of claim 1, wherein the perovskite has an ABO₃ structure, wherein A is at least one selected from the group consisting of lanthanum (La), calcium (Ca) and strontium (Sr), and B is at least one transition metal selected from the group consisting of manganese (Mn), iron (Fe), nickel (Ni) and cobalt (Co).

4. The oxygen carrier particles of claim 1, wherein a molar ratio of the metal oxide to the perovskite is 1:10 to 10:1.

5. A method of preparing the oxygen carrier particles of claim 1, the method comprises:
(a) mixing a metal oxide nanoparticle suspension and a chelate solution containing a perovskite precursor, and drying a mixture; and
(b) calcining the dried mixture, followed by cooling and powdering.

6. The method preparing the oxygen carrier particles of claim 5, comprising:
(a) dissolving metal oxide nanoparticles in a solvent, allowing the solution to stand, and then collecting a nanoparticle suspension from a lower layer of separated layers resulting from separation of the solution into layers;
(b) adding a chelating agent to a perovskite precursor solution to obtain a chelate solution;
(c) mixing the nanoparticle suspension of (a) with the chelate solution of step (b), and drying the mixture; and
(d) calcining the dried mixture of (c) at 450 to 900° C., followed by cooling to room temperature and powdering.

7. A method of producing hydrogen from water by subjecting water to a chemical-looping thermochemical splitting reaction using a reducing agent and the oxygen carrier particles of claim 1.

8. A method of producing carbon monoxide from carbon dioxide by subjecting carbon dioxide to a chemical-looping thermochemical splitting reaction using a reducing agent and the oxygen carrier particles of claim 1.

9. A method of preparing hydrogen and carbon monoxide from water and carbon dioxide by subjecting water and carbon dioxide to a chemical-looping thermochemical splitting reaction using a reducing agent and the oxygen carrier particles of claim 1.

10. The method of claim 7, wherein the reducing agent is at least one selected from the group consisting of methane, hydrogen and carbon monoxide.

11. The method of claim 9, comprising:
(a) reducing the oxygen carrier particles while creating oxygen vacancies on the surface of the oxygen carrier particles using at least one reducing agent selected from the group consisting of methane, hydrogen and carbon monoxide in a reduction reactor;
(b) re-oxidizing the reduced oxygen carrier particles of step (a) by exposure to a water atmosphere in an oxidation reactor to obtain hydrogen; and
(c) re-oxidizing the reduced oxygen carrier particles of step (a) by exposure to a carbon dioxide atmosphere in an oxidation reactor to obtain carbon monoxide.

12. The method of claim 11, further comprising, after step (b) or step (c), step (d) of re-oxidizing the oxygen carrier particles with air or an oxygen-containing gas to obtain additionally oxidized oxygen carrier particles.

13. The method of claim 7, wherein the contact time between the reducing agent and the oxygen carrier particles in the reduction reactor in step (a) is 0.1 to 1,000 L/g catalyst*hr at an absolute pressure of 0.01 to 100 atm.

14. The method of claim 7, wherein the contact time between water or carbon dioxide and the oxygen carrier particles in the oxidation reactor in step (b) or (c) is 0.1 to 1,000 L/g catalyst*hr at an absolute pressure of 0.01 to 100 atm.

15. The method of claim 7, wherein the reaction is performed at a temperature of 100 to 1,200° C. for 0.1 minutes to 2 hours.

16. The method of claim 8, wherein the reducing agent is at least one selected from the group consisting of methane, hydrogen, and carbon monoxide.

17. The method of claim 9, wherein the reducing agent is at least one selected from the group consisting of methane, hydrogen, and carbon monoxide.

18. The method of claim 8, wherein the contact time between the reducing agent and the oxygen carrier particles in the reduction reactor in step (a) is 0.1 to 1,000 L/g catalyst*hr at an absolute pressure of 0.01 to 100 atm.

19. The method of claim 8, wherein the contact time between water or carbon dioxide and the oxygen carrier particles in the oxidation reactor in step (b) or (c) is 0.1 to 1,000 L/g catalyst*hr at an absolute pressure of 0.01 to 100 atm.

20. The method of claim 8, wherein the reaction is performed at a temperature of 100 to 1,200° C. for 0.1 minutes to 2 hours.

21. The method of claim 9, wherein the contact time between the reducing agent and the oxygen carrier particles in the reduction reactor in step (a) is 0.1 to 1,000 L/g catalyst*hr at an absolute pressure of 0.01 to 100 atm.

22. The method of claim 9, wherein the contact time between water or carbon dioxide and the oxygen carrier particles in the oxidation reactor in step (b) or (c) is 0.1 to 1,000 L/g catalyst*hr at an absolute pressure of 0.01 to 100 atm.

23. The method of claim 9, wherein the reaction is performed at a temperature of 100 to 1,200° C. for 0.1 minutes to 2 hours.
